(19) United States
(12) Patent Application Publication
(10) Pub. No.: US 2020/0291984 A1
(43) Pub. Date: Sep. 17, 2020

(54) ANTI-LOOSE STRUCTURE OF ENGAGING MEMBER

(71) Applicant: TING-JUI WANG, New Taipei City (TW)

(72) Inventor: TING-JUI WANG, New Taipei City (TW)

(21) Appl. No.: 16/817,636

(22) Filed: Mar. 13, 2020

(30) Foreign Application Priority Data
Mar. 15, 2019 (TW) 108203208

(51) Int. Cl. F16B 41/00; F16B 5/02

(52) U.S. Cl. CPC F16B 41/002; F16B 5/0266

(57) ABSTRACT

An anti-loose structure includes a head, a body and an anti-loose member. The head includes an engaging portion for assembling with a first object or a second object. The body is joined with the head. The anti-loose member is provided between the head and the body or between the head and the first object, and can be abutted against the head and the body or abutted against the head and the first object to prevent loosening of or to tighten the engaging portion assembled at the first object or the second object. Thus, once the engaging portion is engagingly connected to the first object or the second object, the engaging portion assembled at the first object or the second object is tightened by using the anti-loose member, so as to prevent loosening or moving of the first object or second object, thus achieving an effect of secure joining.

### CROSS-REFERENCE TO RELATED APPLICATION

This non-provisional application claims priority under 35 U.S.C. § 119(a) on Patent Application No(s). 108203208 filed in Taiwan, R.O.C. on Mar. 15, 2019, the entire contents of which are hereby incorporated by reference.

### BACKGROUND OF THE INVENTION

### 1. Field of the Invention

The present invention relates to an anti-loose structure of an engaging member and, more particularly, to an anti-loose structure of an engaging member capable of preventing a first object or a second object from loosening or moving after joining, thus achieving secure joining.

### 2. Description of the Related Art

A screw is usually used for lock connection when at least one object is joined so as to join the object.

However, although the conventional fixing means above is capable of fixedly joining at least one object by a form that is not easily separated, such means can result in instability after assembly.

Therefore, it is an object of the present invention to disclose an anti-loose structure of an engaging member in the aim of preventing loosening or moving after joining of a first object or a second object, thus achieving the object of secure joining.

### BRIEF SUMMARY OF THE INVENTION

In view of the issues and drawbacks of the prior art described above, the Inventor has dedicated to improvement and research in the aim of developing an anti-loose structure of an engaging member capable of preventing loosening or moving after joining of a first object or a second object, thus achieving the object of secure joining.

To achieve the above and other objects, the present invention provides an anti-loose structure of an engaging member. The anti-loose structure of an engaging member includes a head, a body and an anti-loose member. The head includes an engaging portion for assembling with a first object or a second object. The body is joined with the head. The anti-loose member is provided between the head and the body or between the head and the first object, and can be abutted against the head and the body or abutted against the head and the first object, so as to prevent loosening of or to tighten the engaging portion assembled at the first object or the second object.

The present invention further provides an anti-loose structure of an engaging member, the anti-loose structure including: a head and an anti-loose member. The head includes an engaging portion for assembling with a first object or a second object. The anti-loose member is provided between the head and the first object, and can be abutted against the head and the first object, so as to prevent loosening of or to tighten the engaging portion assembled at the first object or the second object.

In the anti-loose structure of an engaging member above, the anti-loose member is an elastic rod, an anti-loose rod, a rod, a spring, an elastic piece, an elastic engaging body, a foam sponge, a colloid, a soft body, an elastic body, a washer or a disk.

In the anti-loose structure of an engaging member above, the engaging portion is a threaded body, a rod, an outer engaging body, an inner engaging body or a hook engaging body.

In the anti-loose structure of an engaging member above, the head and the body are movably joined.

In the anti-loose structure of an engaging member above, an elastic element is provided between the head and the body, and the elastic element is for abutting against the head and the body to perform elastic movement.

In the anti-loose structure of an engaging member above, to operate the engaging member, the head is lifted by using the elastic element to facilitate operation of the engaging portion that is then fitted in an engaged portion of the first object or the second object, and a space between the engaging portion and the engaged portion is constricted by compressing the anti-loose member, so as to prevent loosening or moving.

In the anti-loose structure of an engaging member above, the body includes a shoulder, and the anti-loose member is provided between the shoulder and the head or provided at the shoulder.

In the anti-loose structure of an engaging member above, the body includes an assembly portion, and the assembly portion is for joining with the first object.

In the anti-loose structure of an engaging member above, a height limiting structure is provided at the head or the body or between the head and the body to limit a compression anti-loose distance or space between the head and the first object or between the head and the body, so as to compress the anti-loose member to an anti-loose compression height.

In the anti-loose structure of an engaging member above, the head includes a height limiting structure to limit the anti-loose compression height by which the anti-loose member is compressed between the head and the first object.

In the anti-loose structure of an engaging member above, the anti-loose member has a first height, and the anti-loose member forms a second height after having been compressed by the head.

In the anti-loose structure of an engaging member above, the first height is more than the second height.

In the anti-loose structure of an engaging member above, the anti-loose member is for constricting a space between the engaging portion and the first object or the second object so as to prevent loosening or moving.

In the anti-loose structure of an engaging member above, a height by which the anti-loose member is compressed is between 0.01 mm and 50 mm.

In the anti-loose structure of an engaging member above, the material of the anti-loose member is a metal, plastic, silicone, solid sponge, rubber or synthetic colloid.

In the anti-loose structure of an engaging member above, the engaging portion is fitted in an engaged portion of the first object or the second object, and a space between the engaging portion and the engaged portion is constricted by compressing the anti-loose member so as to prevent loosening or moving.

In the anti-loose structure of an engaging member above, the anti-loose member is placed in a groove or a hole inside the body, and a spatial structure or a height structure of the groove or the hole is used as a limiting structure for limiting a compression amount of the anti-loose member.

In the anti-loose structure of an engaging member above, the anti-loose member is placed in a groove or a hole inside the body, and a spatial structure or a height structure of the groove or the hole is used as a limiting structure for limiting a compression amount of the elastic element.

In the anti-loose structure of an engaging member above, the body or the head includes a restraining portion for stopping or interfering the anti-loose member so as to prevent wavering or moving of the anti-loose member.

In the anti-loose structure of an engaging member above, the head includes a restraining portion for stopping or interfering the anti-loose member so as to prevent moving or wavering of the anti-loose member.

In the anti-loose structure of an engaging member above, the anti-loose member includes a corresponding restraining portion for stopping or interfering the head or the body so as to prevent moving or wavering of the anti-loose member.

In the anti-loose structure of an engaging member above, the anti-loose member includes a corresponding restraining portion for stopping or interfering the head so as to prevent moving or wavering of the anti-loose member.

In the anti-loose structure of an engaging member above, the restraining portion is a protrusion, a recess, a stepped portion, a toothed portion, an inclined surface portion, a curved surface portion or an arc surface portion.

In the anti-loose structure of an engaging member above, the corresponding restraining portion is a protrusion, a recess, a stepped portion, a toothed portion, an inclined surface portion, a curved surface portion or an arc surface portion.

In the anti-loose structure of an engaging member above, after the engaging portion is fitted in an engaged portion of the first object or the second object, a counterforce of the anti-loose member is abutted against the head by compressing the anti-loose member to constrict a space between the engaging portion and the engaged portion, so as to prevent loosening or moving.

In the anti-loose structure of an engaging member above, after the engaging portion is fitted in an engaged portion of the first object or the second object, a counter frictional force of the anti-loose member is abutted against the head by compressing the anti-loose member to constrict a space between the engaging portion and the engaged portion, so as to prevent loosening or moving.

In the anti-loose structure of an engaging member above, after the engaging portion is fitted in an engaged portion of the first object or the second object, a counter abutting force of the anti-loose member is abutted against the head by compressing the anti-loose member to constrict a space between the engaging portion and the engaged portion, so as to prevent loosening or moving.

In the anti-loose structure of an engaging member above, after the engaging portion is fitted in an engaged portion of the first object or the second object, an elastic force of the anti-loose member is abutted against the head by compressing the anti-loose member to constrict a space between the engaging portion and the engaged portion, so as to prevent loosening or moving.

In the anti-loose structure of an engaging member above, after the engaging portion is fitted in an engaged portion of the first object or the second object, a frictional force of the anti-loose member is abutted against the head by compressing the anti-loose member to constrict a space between the engaging portion and the engaged portion, so as to prevent loosening or moving.

In the anti-loose structure of an engaging member above, after the engaging portion is fitted in an engaged portion of the first object or the second object, an abutting force of the anti-loose member is abutted against the head by compressing the anti-loose member to constrict a space between the engaging portion and the engaged portion, so as to prevent loosening or moving.

In the anti-loose structure of an engaging member above, the anti-loose member is assembled at the head.

In the anti-loose structure of an engaging member above, the anti-loose member is inwardly abutted against the first object or is outwardly abutted against the first object.

In the anti-loose structure of an engaging member above, the anti-loose member is made of a plastic material or a non-metal material and formed by in-mold injection.

In the anti-loose structure of an engaging member above, the head is made of a metal material.

Accordingly, the anti-loose structure of an engaging member of the present invention can be engagingly connected to the first object or the second object by the engaging portion, and the engaging portion assembled at the first object or the second object is tightened by the anti-loose member, so as to prevent loosening or moving of the first object or the second object, thereby achieving the object of secure joining.

### BRIEF DESCRIPTION OF THE DRAWINGS

FIG. 1 is a schematic diagram of a state of use according to a first embodiment of the present invention.

FIG. 2 is a schematic diagram of different forms of an anti-loose member of the present invention.

FIG. 3 is a schematic diagram of different forms of an engaging portion of the present invention.

FIG. 4 is a schematic diagram of a state of use according to a second embodiment of the present invention.

FIG. 5 is a schematic diagram of a state of use according to a third embodiment of the present invention.

FIG. 6 is a schematic diagram of a state of use according to a fourth embodiment of the present invention.

FIG. 7 is a schematic diagram of a state of use according to a fifth embodiment of the present invention.

FIG. 8 is a schematic diagram of a state of use according to a sixth embodiment of the present invention.

FIG. 9 is a schematic diagram of a state of use according to a seventh embodiment of the present invention.

FIG. 10 is a schematic diagram of a state of use according to an eighth embodiment of the present invention.

FIG. 11 is a schematic diagram of a state of use according to a ninth embodiment of the present invention.

FIG. 12 is a schematic diagram of a state of use according to a tenth embodiment of the present invention.

FIG. 13 is a schematic diagram of a state of use according to an eleventh embodiment of the present invention.

FIG. 14 is a schematic diagram of a state of use according to a twelfth embodiment of the present invention.

FIG. 15 is a schematic diagram of a state of use according to a thirteenth embodiment of the present invention.

FIG. 16 is a schematic diagram of a state of use according to a fourteenth embodiment of the present invention.

FIG. 17 is a schematic diagram of a state of use according to a fifteenth embodiment of the present invention.

FIG. 18 is a schematic diagram of a state of use according to an eighteenth embodiment of the present invention.

### DETAILED DESCRIPTION OF THE INVENTION

To fully understand the objects, features and effects of the present invention, details of the present invention are described with the accompanying drawings in the specific embodiments below.

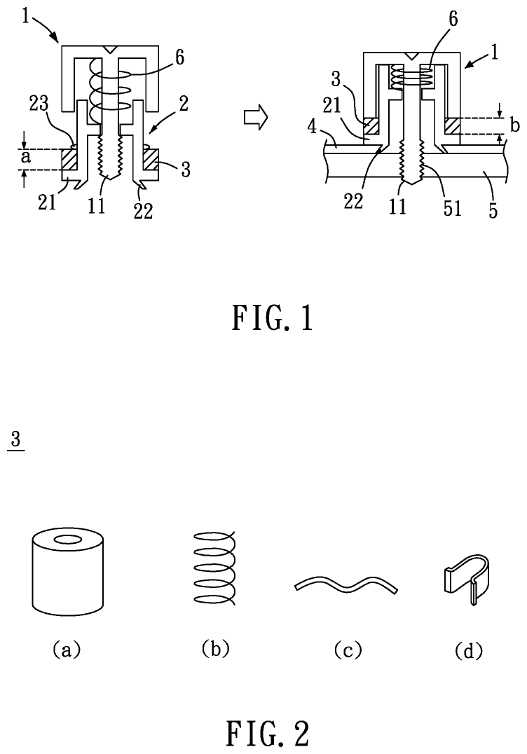

Referring to FIG. 1 and FIG. 2, as shown in the drawings, the present invention provides an anti-loose structure of an engaging member, the anti-loose structure including a head 1, a body 2 and an anti-loose member 3.

The head 1 includes an engaging portion 11 for assembling with a first body 4 or a second body 5.

The body 2 is movably joined with the head 1.

The anti-loose member 3 is provided between the head 1 and the body 2 (or provided between the head 1 and the first object 4, not shown). The anti-loose member 3 can be abutted against the head 1 and the body 2 (or abutted against the head 1 and the first object 4), so as to prevent loosening of and to tighten the engaging portion 11 assembled at the first object 4 or the second object 5.

To put to use, the body 2 can be placed at the first object 4, and a force is applied to the head 1 to assemble the engaging portion 11 with the second object 5. When the engaging portion 11 is assembled with the second object 5, the anti-loose member 3 can be abutted between the head 1 and the body 2 to prevent loosening of and to tighten the engaging portion 11 assembled at the second object 5, so as to prevent loosening or moving of the second object 5, thereby achieving the object of secure joining.

In a preferred embodiment of the present invention, the anti-loose member 3 can be an elastic rod (as part a shown in FIG. 2), an anti-loose rod, a rod, a spring (as part b shown in FIG. 2), an elastic piece (as part c shown in FIG. 2), an elastic engaging body (as part d shown in FIG. 2), a foam sponge, a colloid, a soft body, an elastic body, a washer or a disk, enabling the present invention to respond to requirements of different utilization conditions.

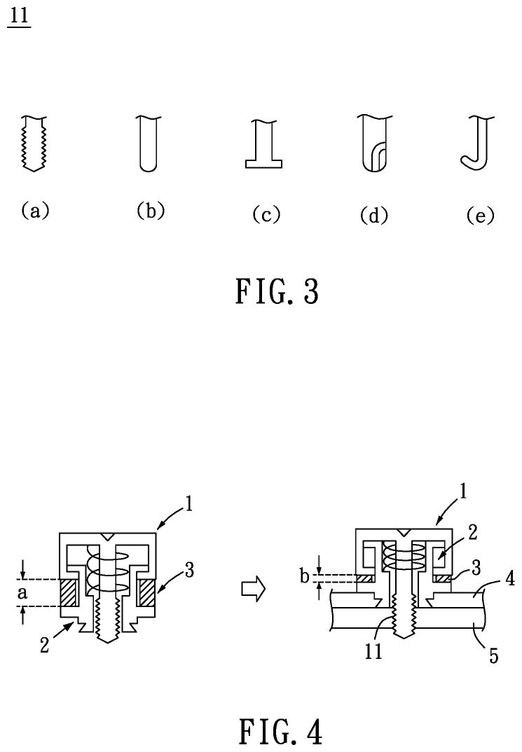

In a preferred embodiment of the present invention, the engaging portion 11 can be a threaded body (as part a shown in FIG. 3), a rod (as part b shown in FIG. 3), an outer engaging body (as part c shown in FIG. 3), an inner engaging body (as part d shown in FIG. 3), or a hook engaging body (as part e shown in FIG. 3), enabling the present invention to respond to requirements of different utilization conditions.

In a preferred embodiment of the present invention, the material of the anti-loose member 3 is a metal, plastic, silicone, solid sponge, rubber or synthetic colloid, enabling the present invention to respond to requirements of different utilization conditions.

In a preferred embodiment of the present invention, an elastic element 6 is provided between the head 1 and the body 2. The elastic element 6 is for abutting against the head 1 and the body 2 so as to perform elastic movement. To operate the engaging member 11, the head 1 is first lifted by the elastic element 6 to facilitate operation of the engaging portion 11, and after the engaging portion 11 is fitted in an engaged portion 51 of the second object 5 (or the first object 4), a space between the engaging portion 11 and the engaged portion 51 is constricted by compressing the anti-loose member 3, so as to prevent loosening or moving of the second object 5, thus achieving the object of secure joining.

In a preferred embodiment of the present invention, the body 2 includes a shoulder 21, and the anti-loose member 3 is provided between the shoulder 21 and the head 1 or provided at the shoulder 21. Thus, when the engaging portion 11 is assembled with the second object 5, the anti-loose member 3 can be abutted between the head 1 and the shoulder 21 of the body 2 to prevent loosening and to tighten the engaging portion 11 assembled at the second object 5, so as to prevent loosening or moving of the second object 5, thereby achieving the object of secure joining.

In a preferred embodiment of the present invention, the body 2 includes an assembly portion 22, and the assembly portion 22 is used for joining with the first object 4. Thus, the body 2 can be securely joined with the first object 4 by using the assembly portion 22.

In a preferred embodiment of the present invention, the anti-loose member 3 has a first height a, and the anti-loose member 3 forms a second height b after having been compressed by the head 1, wherein the first height a is more than the second height b. Hence, when the engaging portion 11 has not yet assembled with the second object 5, the anti-loose member 3 is located at the first height a; when the engaging portion 11 is assembled with the second object 5, the anti-loose member 3 can be abutted between the head 1 and the shoulder 21, the anti-loose member 3 at this point in time is located at the second height b, and the height by which the anti-loose member 3 is compressed is between 0.01 mm and 50 mm. Thus, the engaging portion 11 assembled at the second object 5 is prevented from loosening and can be tightened, so as to prevent loosening or moving of the second object 5, thereby achieving the object of secure joining.

In a preferred embodiment of the present invention, when the engaging portion 11 is assembled with the second object 5, the anti-loose member 3 can constrict a space between the engaging portion 11 and the first object 4 or the second object 5 to prevent loosening or moving. Furthermore, when the engaging portion 11 is fitted in the engaged portion 51 of the second object 5 (or the first object 4), a counterforce, a counter frictional force, a counter abutting force, an elastic force, a frictional force or an abutting force of the anti-loose member 3 can be abutted against the head 1 by compressing the anti-loose member 3 to constrict a space between the engaging portion 11 and the engaged portion 51, so as to prevent loosening or moving.

In a preferred embodiment of the present invention, the body 2 includes a restraining portion 23 for stopping or interfering the anti-loose member 3 so as to prevent the anti-loose member 3 from wavering or moving, wherein the restraining portion 23 can be a protrusion, a recess, a stepped portion, a toothed portion, an inclined surface portion, a curved surface portion or an arc surface portion.

Referring to FIG. 4, as shown in the drawing, in a preferred embodiment of the present invention, the head 1 and the body 2 are in different forms, so as to respond to requirements of different utilization conditions. In addition, in this embodiment, when the engaging portion 11 has not yet assembled with the second object 5, the anti-loose member 3 can be similarly located at the first height a; when the engaging portion 11 is assembled with the second object 5, the anti-loose member 3 can be abutted between the head 1 and the body 2, and the anti-loose member 3 is located at the second height b at this point in time. Accordingly, the engaging portion 11 assembled at the second object 5 can be prevented from loosening and be tightened, so as to prevent loosening or moving of the second object 5, thereby achieving the object of secure joining.

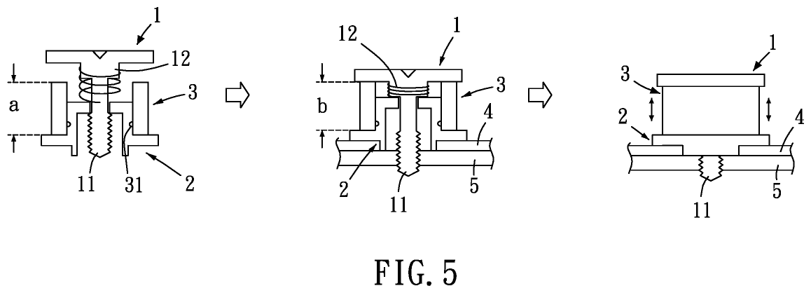

Referring to FIG. 5, as shown in the drawing, in a preferred embodiment of the present invention, the head 1 includes a height limiting structure 12 for limiting a compression anti-loose distance or space between the head 1 and the body 2, so as to compress the anti-loose member 3 to an anti-loose compression height. Furthermore, the height limiting structure 12 can also be provided at the head 1 or between the head 1 and the body 2 to limit a compression anti-loose distance or space (not shown) between the head 1 and the first object 4. Similarly, when the engaging portion 11 has not yet assembled with the second object 5, the anti-loose member 3 is located at the first height a; when the engaging portion 11 is assembled with the second object 5, the anti-loose member 3 can be abutted between the head 1 and the body 2, and the anti-loose member 3 is located at the second height b at this point in time. Accordingly, the engaging portion 11 assembled at the second object 5 can be prevented from loosening and be tightened, so as to prevent loosening or moving of the second object 5, thereby achieving the object of secure joining.

Furthermore, the anti-loose member 3 includes a corresponding restraining portion 31 for stopping or interfering the head 1 or the body 2 so as to prevent the anti-loose member 3 from moving or wavering. The corresponding restraining portion 31 can be a protrusion, a recess, a stepped portion, a toothed portion, an inclined surface portion, a curved surface portion or an arc surface portion.

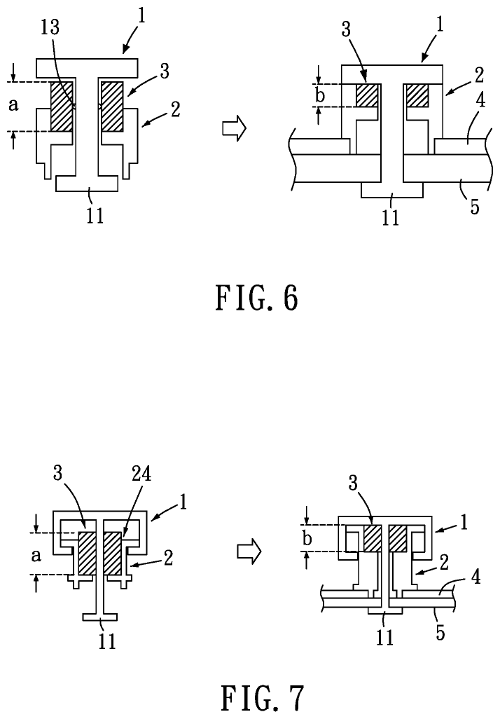

Referring to FIG. 6, as shown in the drawing, in a preferred embodiment of the present invention, the engaging portion 11 is an outer engaging portion, the anti-loose member 3 is provided on an inner side of the body 2, and the head 1 includes a restraining portion 13 for stopping or interfering the anti-loose member 3 so as to prevent moving or wavering of the anti-loose member 3. Hence, similarly, when the engaging portion 11 has not yet assembled with the second object 5, the anti-loose member 3 is located at the first height a; when the engaging portion 11 is assembled with the second object 5, the anti-loose member 3 can be abutted between the head 1 and the body 2, and the anti-loose member 3 is located at the second height b at this point in time. Accordingly, the engaging portion 11 assembled at the second object 5 can be prevented from loosening and be tightened, so as to prevent loosening or moving of the second object 5, thereby achieving the object of secure joining.

Referring to FIG. 7, as shown in the drawing, in a preferred embodiment of the present invention, the head 1 and the body 2 are in forms different from those shown in FIG. 6, the engaging portion 11 is an outer engaging portion, and the anti-loose member 3 is provided on an inner side of the body 2. More specifically, the anti-loose member 3 is provided in a groove 24 (or a hole) inside the body 2, and a spatial structure or a height structure of the groove 24 (or hole) is used as the limiting structure limiting a compression amount of the anti-loose member 3. Thus, similarly, when the engaging portion 11 has not yet assembled with the second object 5, the anti-loose member 3 is located at the first height a; when the engaging portion 11 is assembled with the second object 5, the anti-loose member 3 can be abutted between the head 1 and the body 2, and the anti-loose member 3 is located at the second height b at this point in time. Accordingly, the engaging portion 11 assembled at the second object 5 can be prevented from loosening and be tightened, so as to prevent loosening or moving of the second object 5, thereby achieving the object of secure joining.

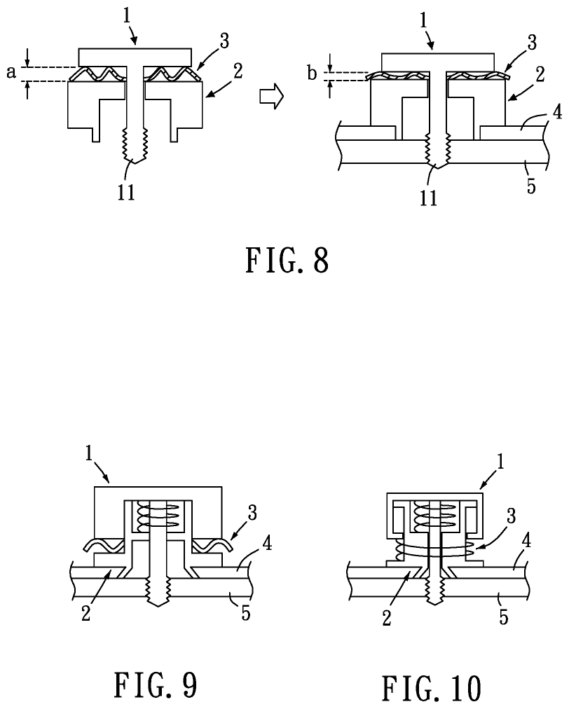

Referring to FIG. 8 to FIG. 10, as shown in the drawings, in a preferred embodiment of the present invention, the anti-loose member 3 is an elastic piece, and the engaging portion 11 is a threaded body (as shown in FIG. 8) or can be implemented as the forms shown in FIG. 9 or FIG. 10. Thus, similarly, when the engaging portion 11 has not yet assembled with the second object 5, the anti-loose member 3 is located at the first height a; when the engaging portion 11 is assembled with the second object 5, the anti-loose member 3 can be abutted between the head 1 and the body 2, and the anti-loose member 3 is located at the second height b at this point in time. Accordingly, the engaging portion 11 assembled at the second object 5 can be prevented from loosening and be tightened, so as to prevent loosening or moving of the second object 5, thereby achieving the object of secure joining.

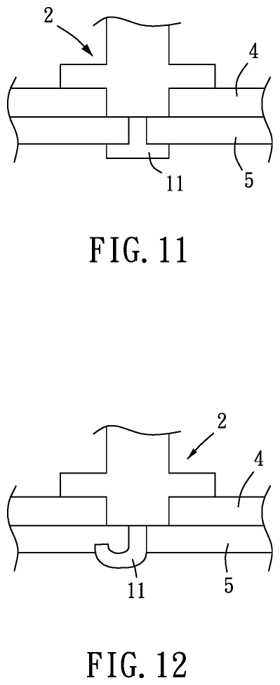

Referring to FIG. 11 and FIG. 12, as shown in the drawings, in a preferred embodiment of the present invention, when the engaging portion 11 is an outer engaging body, the assembly of the engaging portion 11 and the second object 5 is as shown in FIG. 11; when the engaging portion 11 is a hook engaging body, the assembly of the engaging portion 11 and the second object 5 is as shown in FIG. 11, enabling the present invention to respond to requirements of different utilization conditions.

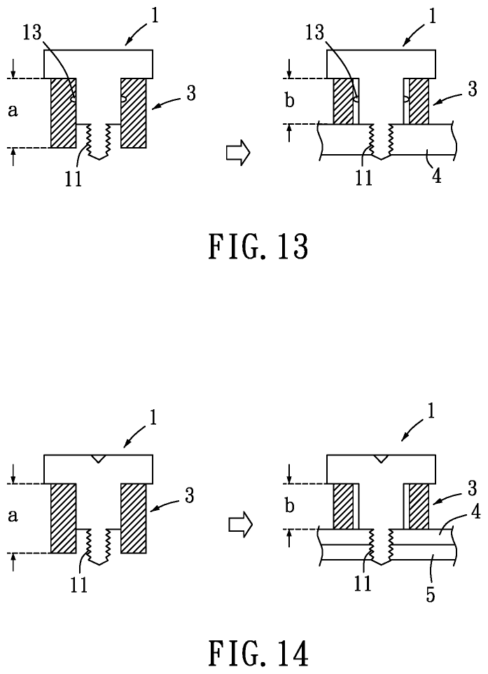

Referring to FIG. 13 and FIG. 14, as shown in the drawings, in a preferred embodiment of the present invention, the anti-loose structure of an engaging member includes a head 1 and an anti-loose member 3. The head 1 includes an engaging portion 11, and the anti-loose member 3 is provided between the head 1 and the first object 4. The engaging portion 11 is for assembling with the first object 4, allowing the anti-loose member 3 to be abutted against the head 1 and the first object 4, so as to prevent loosening of and to be tightened and assembled to the first object 4 (as shown in FIG. 13). Furthermore, the head 1 includes a restraining portion 13 for stopping or interfering the anti-loose member 3 so as to prevent the anti-loose member 3 from moving or wavering. Moreover, the engaging portion 11 can be assembled with the first object 4 and the second object 5, allowing the anti-loose member 3 to be abutted against the head 1 and the first object 4, so as to prevent loosening of and to tighten the engaging portion 11 assembled at the first object 4 and the second object 5. In addition, when the engaging portion 11 has not yet assembled with the first object 4 or the second object 5, the anti-loose member 3 is located at the first height a; when the engaging portion 11 is assembled with the first object 4 or is simultaneously assembled with the first object 4 and the second object 5, the anti-loose member 3 can be abutted between the head 1 and the first object 4, and the anti-loose member 3 is located at the second height b at this point in time. Accordingly, loosening or moving of the first object 4 or the second object 5 is prevented, thereby achieving the object of secure joining.

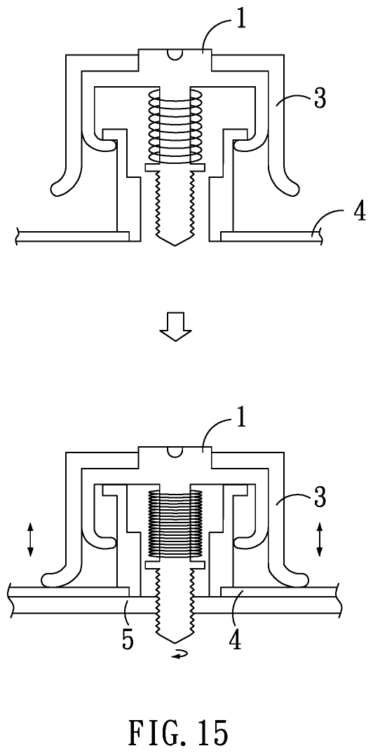

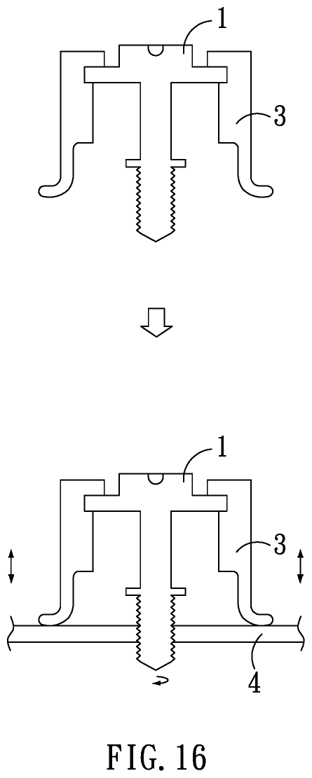

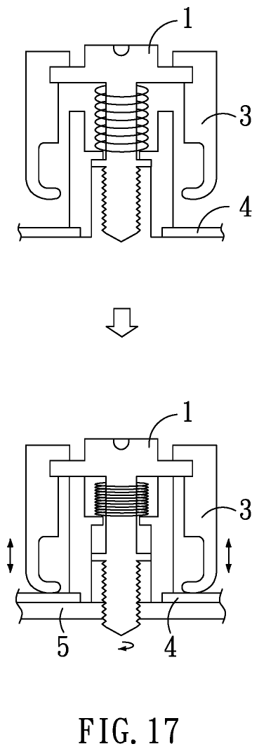

Referring to FIG. 15 to FIG. 17, as shown in the drawings, in a preferred embodiment of the present invention, the anti-loose member 3 is assembled at the head 1 to allow the anti-loose member 3 to be inwardly abutted against the first object 4 (as shown in FIG. 16), or to allow the anti-loose member 3 to be outwardly abutted against the first object 4 (as shown in FIG. 17), so as to prevent loosening or moving of the first object 4 or the second object 5, thereby achieving the object of secure joining.

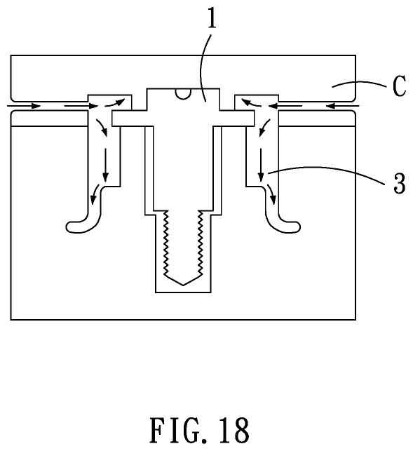

Referring to FIG. 18, as shown in the drawing, in a preferred embodiment of the present invention, the anti-loose member 3 can be made of a plastic material or a non-metal material, and the head 1 can be made of a metal material. Furthermore, the anti-loose member 3 can be assembled at the head 1 and formed by in-mold injection in conjunction with a mold c. Thus, the anti-loose member 3 can achieve an effect of being securely assembled at the head 1.

While the present invention has been disclosed by way of preferred embodiments above, it is to be understood by a person skilled in the art that, the embodiments are illustrative of the present invention and are not to be construed as limitations to the scope of the present invention. It should be noted that, equivalent modifications and substitutions made to the embodiments are to be encompassed within the scope of the present invention. Therefore, the legal protection of the present invention should be defined by the appended claims.

What is claimed is:

1. An anti-loose structure of an engaging member, comprising:
a head, comprising an engaging portion for assembling with a first object or a second object;
a body, joined with the head; and
an anti-loose member, provided between the head and the body, or provided between the head and the first object, the anti-loose member being capable of abutting against the head and the body or abutting against the head and the first object, for preventing loosening of or for tightening the engaging portion assembled at the first object or the second object.

2. An anti-loose structure of an engaging member, comprising:
a head, comprising an engaging portion for assembling with a first object or a second object; and
an anti-loose member, provided between the head and the first object, the anti-loose member being capable of abutting against the head and the first object, for preventing loosening of or for tightening the engaging portion assembled at the first object or the second object.

3. The anti-loose structure of an engaging member according to claim 1, wherein the head and the body are movably joined.

4. The anti-loose structure of an engaging member according to claim 1, wherein an elastic element is provided between the head and the body, the elastic element is for abutting against the body and the head to perform elastic movement, to operate the engaging member, the head is lifted by using the elastic element to facilitate operation of the engaging portion that is then fitted in an engaged portion of the first object or the second object, and a space between the engaging portion and the engaged portion is constricted by compressing the anti-loose member so as to prevent loosening or moving.

5. The anti-loose structure of an engaging member according to claim 1, wherein the body comprises a shoulder, and the anti-loose member is provided between the shoulder and the head or is provided at the shoulder.

6. The anti-loose structure of an engaging member according to claim 1, wherein the body comprises an assembly portion, and the assembly portion is for joining with the first object.

7. The anti-loose structure of an engaging member according to claim 1, wherein a height limiting structure is provided at the head or the body or between the head and the body to limit a compression anti-loose distance or space between the head and the first object or between the head and the body, so as to compress the anti-loose member to an anti-loose compression height.

8. The anti-loose structure of an engaging member according to claim 2, wherein the head comprises a height limiting structure for limiting an anti-loose compression height by which the anti-loose member is compressed between the head and the first object.

9. The anti-loose structure of an engaging member according to claim 1, wherein the anti-loose member has a first height, the anti-loose member forms a second height after having been compressed by the head, and the first height is more than the second height.

10. The anti-loose structure of an engaging member according to claim 2, wherein the anti-loose member has a first height, the anti-loose member forms a second height after having been compressed by the head, and the first height is more than the second height.

11. The anti-loose structure of an engaging member according to claim 1, wherein the anti-loose member is for constricting a space between the engaging portion and the first object or the second object, so as to prevent loosening or moving.

12. The anti-loose structure of an engaging member according to claim 2, wherein the anti-loose member is for constricting a space between the engaging portion and the first object or the second object, so as to prevent loosening or moving.

13. The anti-loose structure of an engaging member according to claim 1, wherein the engaging portion compresses the anti-loose member after having been fitted in an engaged portion of the first object or the second object to constrict a space between the engaging portion and the engaged portion, so as to prevent loosening or moving.

14. The anti-loose structure of an engaging member according to claim 1, wherein the anti-loose member s provided in a groove or a hole inside the body, and a spatial structure or a height structure of the groove or the hole is used as a limiting structure for limiting a compression amount of the anti-loose member.

15. The anti-loose structure of an engaging member according to claim 4, wherein the anti-loose member is provided in a groove or a hole inside the body, and a spatial structure or a height structure of the groove or the hole is used as a limiting structure for limiting a compression amount of the elastic element.

16. The anti-loose structure of an engaging member according to claim 1, wherein the body or the head comprises a restraining portion for stopping or interfering the anti-loose member, so as to prevent the anti-loose member from wavering or moving.

17. The anti-loose structure of an engaging member according to claim 2, wherein the head comprises a restraining portion for stopping or interfering the anti-loose member, so as to prevent the anti-loose member from moving or wavering.

18. The anti-loose structure of an engaging member according to claim 1, wherein the anti-loose member comprises a corresponding restraining portion for stopping or interfering the head or the body, so as to prevent the anti-loose member from moving or wavering.

19. The anti-loose structure of an engaging member according to claim 2, wherein the anti-loose member comprises a corresponding restraining portion for stopping or interfering the head, so as to prevent the anti-loose member from moving or wavering.

20. The anti-loose structure of an engaging member according to claim 1, wherein the engaging portion compresses the anti-loose member after having been fitted in an engaged portion of the first object or the second object to have a counterforce of the anti-loose member be abutted against the head to constrict a space between the engaging portion and the engaged portion, so as to prevent loosening or moving.

21. The anti-loose structure of an engaging member according to claim 2, wherein the engaging portion compresses the anti-loose member after having been fitted in an engaged portion of the first object or the second object to have a counterforce of the anti-loose member be abutted against the head to constrict a space between the engaging portion and the engaged portion, so as to prevent loosening or moving.

22. The anti-loose structure of an engaging member according to claim 1, wherein the engaging portion compresses the anti-loose member after having been fitted in an engaged portion of the first object or the second object to have a counter frictional force of the anti-loose member be abutted against the head to constrict a space between the engaging portion and the engaged portion, so as to prevent loosening or moving.

23. The anti-loose structure of an engaging member according to claim 2, wherein the engaging portion compresses the anti-loose member after having been fitted in an engaged portion of the first object or the second object to have a counterforce of the anti-loose member be abutted against the head to constrict a space between the engaging portion and the engaged portion, so as to prevent loosening or moving.

24. The anti-loose structure of an engaging member according to claim 1, wherein the engaging portion compresses the anti-loose member after having been fitted in an engaged portion of the first object or the second object to have a counter abutting force of the anti-loose member be abutted against the head to constrict a space between the engaging portion and the engaged portion, so as to prevent loosening or moving.

25. The anti-loose structure of an engaging member according to claim 2, wherein the engaging portion compresses the anti-loose member after having been fitted in an engaged portion of the first object or the second object to have a counter abutting force of the anti-loose member be abutted against the head to constrict a space between the engaging portion and the engaged portion, so as to prevent loosening or moving.

26. The anti-loose structure of an engaging member according to claim 1, wherein the engaging portion compresses the anti-loose member after having been fitted in an engaged portion of the first object or the second object to have an elastic force of the anti-loose member be abutted against the head to constrict a space between the engaging portion and the engaged portion, so as to prevent loosening or moving.

27. The anti-loose structure of an engaging member according to claim 2, wherein the engaging portion compresses the anti-loose member after having been fitted in an engaged portion of the first object or the second object to have an elastic force of the anti-loose member be abutted against the head to constrict a space between the engaging portion and the engaged portion, so as to prevent loosening or moving.

28. The anti-loose structure of an engaging member according to claim 1, wherein the engaging portion compresses the anti-loose member after having been fitted in an engaged portion of the first object or the second object to have a frictional force of the anti-loose member be abutted against the head to constrict a space between the engaging portion and the engaged portion, so as to prevent loosening or moving.

29. The anti-loose structure of an engaging member according to claim 2, wherein the engaging portion compresses the anti-loose member after having been fitted in an engaged portion of the first object or the second object to have a frictional force of the anti-loose member be abutted against the head to constrict a space between the engaging portion and the engaged portion, so as to prevent loosening or moving.

30. The anti-loose structure of an engaging member according to claim 1, wherein the engaging portion compresses the anti-loose member after having been fitted in an engaged portion of the first object or the second object to have an abutting force of the anti-loose member be abutted against the head to constrict a space between the engaging portion and the engaged portion, so as to prevent loosening or moving.

31. The anti-loose structure of an engaging member according to claim 2, wherein the engaging portion compresses the anti-loose member after having been fitted in an engaged portion of the first object or the second object to have an abutting force of the anti-loose member be abutted against the head to constrict a space between the engaging portion and the engaged portion, so as to prevent loosening or moving.

32. The anti-loose structure of an engaging member according to claim 1, wherein the anti-loose member is assembled at the head.

33. The anti-loose structure of an engaging member according to claim 2, wherein the anti-loose member is assembled at the head.

34. The anti-loose structure of an engaging member according to claim 1, wherein the anti-loose member is inwardly abutted against the first object or is outwardly abutted against the first object.

35. The anti-loose structure of an engaging member according to claim 2, wherein the anti-loose member is inwardly abutted against the first object or is outwardly abutted against the first object.

36. The anti-loose structure of an engaging member according to claim 1, wherein the anti-loose member is made of a plastic material or a non-metal material and formed by in-mold injection.

37. The anti-loose structure of an engaging member according to claim 2, wherein the anti-loose member is made of a plastic material or a non-metal material and formed by in-mold injection.

38. The anti-loose structure of an engaging member according to claim 1, wherein the head is made of a metal material.

39. The anti-loose structure of an engaging member according to claim 2, wherein the head is made of a metal material.
